(19) United States
(12) Patent Application Publication
(10) Pub. No.: US 2016/0140499 A1
(43) Pub. Date: May 19, 2016

(54) ENGINEERING DOCUMENT MOBILE COLLABORATION TOOL

(71) Applicant: GENERAL ELECTRIC COMPANY, SCHENECTADY, NY (US)

(72) Inventors: AARON R. MITTI, ATLANTA, GA (US); JEFFREY FRIES, LEE'S SUMMIT, MO (US); RICHARD L. LAWSON, MELBOURNE BEACH, FL (US); ARIC WEINGARTNER, LEE'S SUMMIT, MO (US); CURTIS D. MECHLING, FLEMING ISLAND, FL (US); MARTIN PAGET, Saint Johns, FL (US); WILLIAM SHIELDS, SCHENECTADY, NY (US)

(21) Appl. No.: 14/547,806

(22) Filed: Nov. 19, 2014

(51) Int. Cl. G06Q 10/10; G06F 17/30; G06Q 10/06

(52) U.S. Cl. CPC G06Q 10/10; G06Q 10/0633; G06F 17/30011

(57) ABSTRACT

Systems and methods provide engineering process and document management to a mobile fleet of users. A server computer and a relational database form at least part of a process and document management system. The server computer processes information from the relational database to predictably identify workflow information and engineering document information that may be needed by one or more users in the field to service field assets. The server computer may push the identified information to one or more mobile devices of the one or more users in the field via one or more communication networks. The mobile devices allow users to mark-up engineering documents in the field and provide the modified documents back to the server computer.

### BACKGROUND

1. Technical Field

The subject matter disclosed herein relates to providing engineering process and document management to a mobile fleet of users.

2. Discussion of Art

Workers in the field (e.g., maintenance and construction workers for a railroad) rely on office workers (e.g., engineers, clerks, and project managers) to track down drawings, mail paper back and forth, and provide workflow information and engineering drawings to the workers in the field, often in the form of paper. The office workers may have access to a web-based engineering document system and may have to laboriously search the web-based system to find the proper workflow information and engineering drawings that are needed by a particular worker in the field for a particular job. The office workers may then have to print out the workflow information and engineering drawings and mail the workflow information and engineering drawings to locations where the workers in the field can pick them up. The workers in the field may use pencils, pens, or other types of markers to mark-up the paper engineering drawings as they work in the field. The marked-up engineering drawings may then have to be mailed back to the office workers. Such an arduous process can be inefficient and costly.

It may be desirable to have a system and method for electronically and/or digitally providing engineering process and document management to a mobile fleet of users in the field.

### BRIEF DESCRIPTION

An engineering process and document management system is provided. The system includes at least one server computer and at least one relational database operatively connected to the at least one server computer and storing workflow information and engineering document information. The server computer is configured to gather external information from external systems via one or more communication networks and logically relate and store the external information in the relational database. The server computer is also configured to access the external information from the relational database and process the external information to predictably identify workflow information and engineering document information that will be needed by one or more users in the field. The server computer is further configured to push the identified workflow information and engineering document information to one or more mobile devices of the one or more users in the field via one or more communication networks.

Alternative or complementarily, a method is provided. The method is performed under the control of a software application running on a mobile device. The method includes the mobile device receiving predictably identified workflow information and engineering document information related to a first field asset from the engineering process and document management system described herein via one or more communication networks. The method may include the mobile device communicatively connecting to the first field asset, and the mobile device guiding a user through a workflow process defined by the workflow information, where the user services (performs at least one of base-lining, assessing, inspecting, testing, debugging, repairing, constructing, or modifying) the first field asset as part of the workflow process.

### BRIEF DESCRIPTION OF THE DRAWINGS

Reference is made to the accompanying drawings in which particular arrangements and further benefits of the disclosure are illustrated as described in more detail in the description below, in which:

FIG. 1 is an illustration of an embodiment of a system providing engineering process and document management to a mobile fleet of users;

FIG. 2 is an illustration of an embodiment of an engineering process and document management system;

FIG. 3 illustrates a flow chart of an embodiment of a method of providing engineering process and document management to a mobile fleet of users using the systems of FIG. 1 and FIG. 2;

FIG. 4 is an illustration of an embodiment of an engineering process and document management system;

FIG. 5 is an illustration of an embodiment of a mobile device of a user in the field communicatively interacting with a field asset and an engineering process and document management system through a communication network; and

FIG. 6 illustrates a flow chart of an embodiment of a method of servicing a field asset using a mobile device that is supported by an engineering process and document management system.

### DETAILED DESCRIPTION

Systems and methods are described providing, for example, process and document management to at least one user in a mobile fleet of users. The technical effect is using a server computer and a relational database to implement an engineering process and document management (EPDM) system. The server computer provides the technical effect of processing information from the relational database to predictably identify workflow information and engineering document information that will be needed by one or more users in the field to service field assets. The server computer provides further technical effects of pushing the identified workflow information and document information to one or more mobile devices of the one or more users in the field via one or more communication networks. Mobile devices provide the technical effect of allowing users to modify engineering documents in the field and provide the modified documents back to the server computer. Suitable documents can include engineering drawings, specifications, instructions, service manuals, wiring diagrams, testing procedures, troubleshooting guides, maintenance checklists, and the like.

With reference to the drawings, like reference numerals designate identical or corresponding parts throughout the several views. However, the inclusion of like elements in different views does not mean a given embodiment necessarily includes such elements or that all embodiments include such elements.

The term “in the field” as used herein may refer to being located outdoors, remotely or away from some central or controlling device, location, or authority (e.g., being located away from an engineering process and document management system). The term “field asset” as used herein refers to an asset being in the field. “Software” or “computer program” as used herein includes, but is not limited to, one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, an application, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

“Computer” or “processing device” or “computing device” or “processor” as used herein includes, but is not limited to, any programmed or programmable device that can store, retrieve, and process data. “Non-transitory computer-readable media” include, but are not limited to, a CD-ROM, a removable flash memory card, a hard disk drive, a magnetic tape, and a floppy disk. “Computer memory”, as used herein, refers to a storage device configured to store digital data or information which can be retrieved by a computer or processing element. The terms “controller” or “control system” or “control device” are used broadly herein and may be anything from a simple switching device, to one or more processors running computer-executable software instructions, to complex programmable and/or non-programmable logic circuitry. The terms “signal”, “data”, and “information” may be used interchangeably herein and may be in digital or analog form.

The term “workflow” as used herein may refer to instructions and directions related to servicing a field asset. The term “document” as used herein may refer to paper or electronic information in a human-readable form. The term “functionality” as used herein may refer to the logical actions and supporting display screens of a system implemented in software and/or hardware. The term “electronically” as used herein may refer to performing a task using an electronic device or network, or any equivalent thereof (e.g., a fiber optic device or network, or some other form of digital device or network). The term “servicing” as used herein may refer to any of base-lining, assessing, inspecting, testing, debugging, repairing, constructing, and modifying an asset in the field. The term “base-lining” as used herein may refer to performing actions to understand the present configuration of an installed field asset, or performing actions to place an installed field asset in a known configuration.

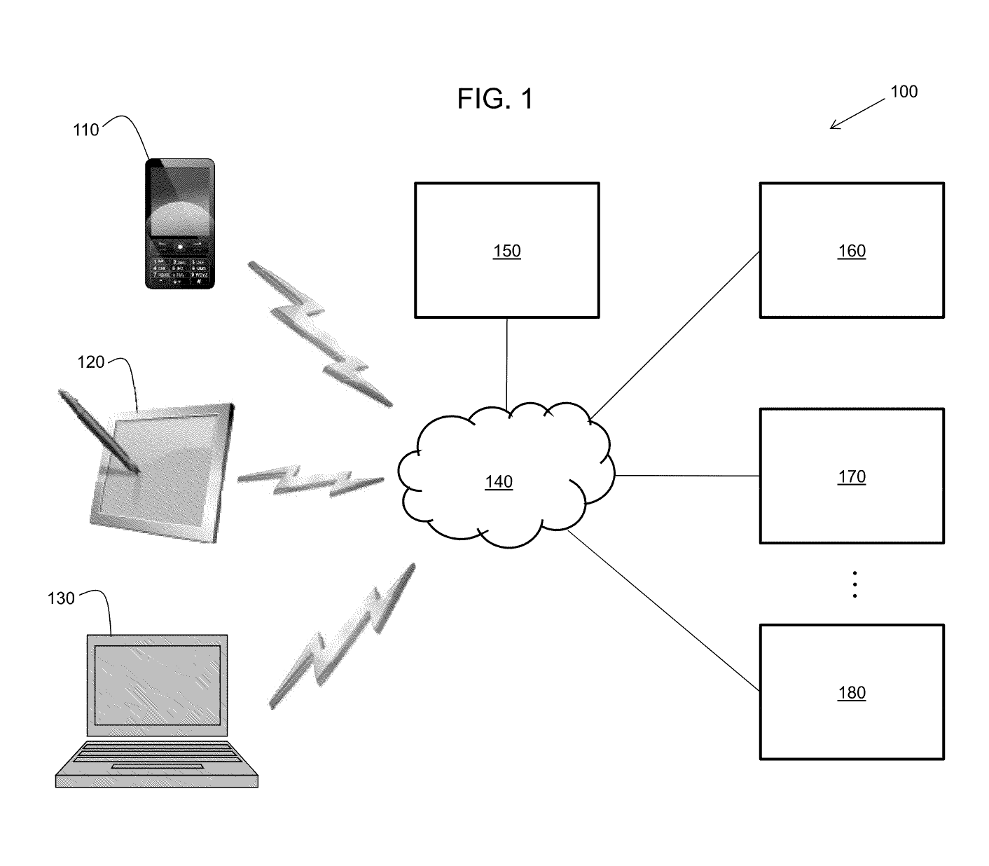

FIG. 1 is an illustration of an example of a system 100 providing engineering process and document management to a mobile fleet of users. The mobile fleet of users may include maintenance workers, technicians, and construction workers who work in the field to construct, install, and repair field assets such as equipment assets (e.g., vehicles, stationary power generators, and the like) and infrastructure assets (e.g., buildings, bridges, wayside equipment, electronic/electrical field assets, and the like). For example, for a railroad industrial segment a vehicle may be a locomotive or railcar and equipment and infrastructure may include lights, switches, control systems, interlocking houses, railroad bridges, track devices, in-cab assets, and crossing gates and signals.

Each user of the mobile fleet of users can be equipped with a mobile device such as, for example, a “smart” phone 110, a tablet computer 120, or a laptop computer 130. The mobile devices are configured to communicate with an engineering process and document management (EPDM) system 150 (a.k.a., management system) via one or more communication networks 140. The communication network 140 may include a cellular telephone network (e.g., a 3G or 4G/LTE network), a Wi-Fi™ communication network, a satellite communication network, the internet, or some combination thereof, for example. Communication may be wired, wireless, or some combination thereof.

The system 150 may be an engineering process and document management (EPDM) system that communicates with one or more external systems via one or more communication networks 140. In the context of a railroad, the external systems may include a long-term maintenance planning system 160, a brake fix task management system 170, and an hours-of-service requirements system 180, for example. Other types of systems are possible as well. The EPDM system 150 can gather external information from the external systems via the one or more communication networks 140. Such external information may include, for example, maintenance schedules for equipment and infrastructure in the field, scheduled availability of field workers (when field workers can work), and train schedules (when trains will be passing by particular locations).

The EPDM system may determine and provide needed information to the mobile devices of the mobile fleet of users in the field in a just-in-time manner by analyzing the external information gathered from the external systems and using the communication infrastructure of the system. In this way, a user in the field that is scheduled to service a field asset or other piece of infrastructure in the field is provided with only the information needed for servicing that field asset or piece of infrastructure when he needs it. As a result, the computer memory of the user's mobile device is not filled up with information that is not needed at a particular time, and the user of the mobile device does not have to search through a myriad of information to find the information he actually needs for a particular service job. Further, not all of the service information available for all types of jobs need be present on the device.

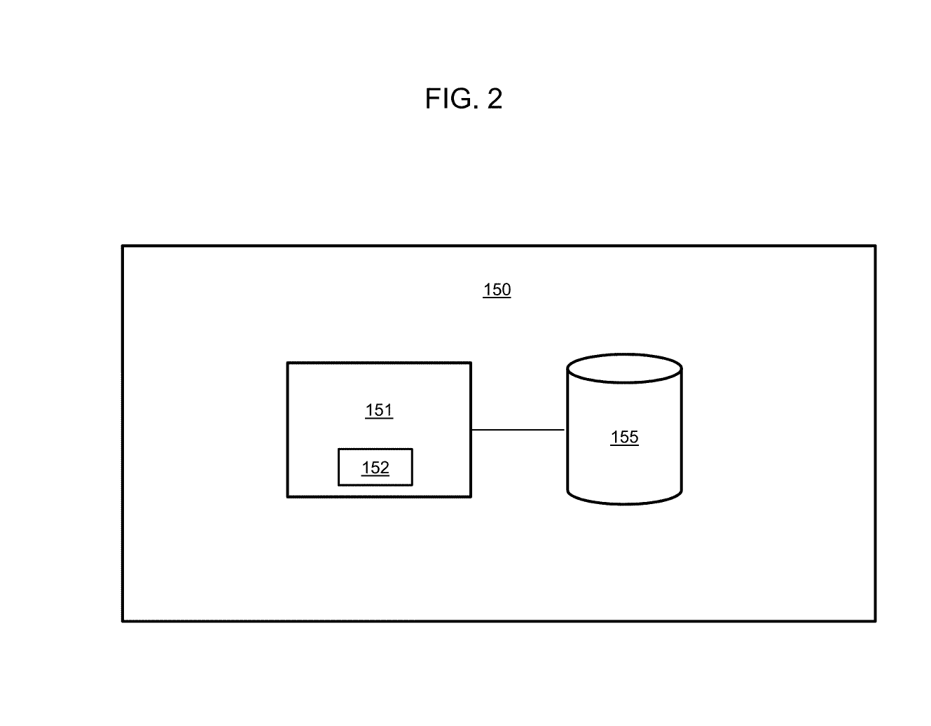

FIG. 2 is an illustration of an example of an engineering process and document management (EPDM) system. The EPDM system includes a server computer 151 operatively connected to a relational database 155. The relational database 155 stores workflow information and engineering document information. Furthermore, the server computer may gather external information (e.g., maintenance schedules for equipment and infrastructure in the field, scheduled availability of field workers, user defined criteria, territory assignments, construction schedules, audits, queues, and train schedules) from external systems via one or more communication networks and logically relate and store the external information in the relational database.

The relational database can be structured such that every document or information entity has a unique (or equivalent) identifier. Any derivative document or information entity may be given an identifier and may be linked to the unique identifier of the parent. Revisions of each document or information entity and the source of the revisions may be tracked and managed in the EPDM system. Each document or information entity may be linked in a hierarchy of data. For example, an engineering drawing may be part of a set of engineering drawings which is named, grouped, and ordered. As another example, a bill of materials (BOM) for an assembly may include the assembly components, as well as the sub-components for each of the assembly components.

The server computer may include a predictive software algorithm (PSA) 152. The server computer may access the external information from the relational database and have the PSA process the external information to predict which workflow information and engineering document information will be needed by one or more users in the field. As an example, based on the external information, the PSA may determine that maintenance worker Mr. Joe Smith is scheduled to repair switching assembly number SW-421A on the side of track TRK-63-WDS in Wadsworth, Ohio at a certain date/time, and that Mr. Smith will need workflow document WFL-G61B and engineering drawing ENG-DRW-421A to aid him in performing the repair.

The server computer may access the workflow document WFL-G61B and the engineering drawing ENG-DRW-421A, convert the engineering drawing from a CAD format to a PDF format, and push the workflow document and the converted engineering drawing to Mr. Smith's mobile device (e.g., a tablet computer). When Mr. Smith arrives at the worksite tomorrow to repair the switching assembly, the information he needs to aid in making the repair (e.g., the workflow document and the engineering drawing) will be readily available on his mobile device. Such anticipation and pushing of information that will be needed is “predictive caching” to a mobile device. Communication with the mobile device at the location at the indicated date/time may be less critical, as the information needed may be retrieved from the local cache on the mobile device.

As part of working on (e.g., servicing) the switching assembly, Mr. Smith may follow a workflow process defined in the workflow document. Furthermore, Mr. Smith may electronically mark-up or modify the engineering drawing, via a user interface of his mobile device, to reflect changes made (e.g., via a touch-sensitive display screen of the mobile device). The changes may be to the switching assembly, additional information about the environment and proximate equipment (which may interact with the switching assembly, or not), and other notes or observations relating to the process. The term “mark-up” refers to a document that includes original text plus new text and/or indications about the changes made (deletions and/or additions), such as underlining new text and cross-through of deleted text. The term “modified” is inclusive of “mark-up”, but further can include the display of the text in only the modified form (without the deleted text and without the symbols of the mark-up, e.g.). The modified document can carry metadata regarding the modifications. One aspect of modification may include graphical capture, such as annotations on a drawing or on a picture; alternatively, the modification may be the additions of a picture, audio or video clip created at the location. Specifics about replacement parts can be captured, e.g., using the mobile device's I/O functionality, and stored in or with the modified document. In this way, serialization of parts and components, their install dates and conditions, and more can be captured with the modified document. The marked-up or modified document can be sent back to the EPDM system via the communication network where the server computer can associate the modified document with one or more master documents and can relationally store the documents in the relational database.

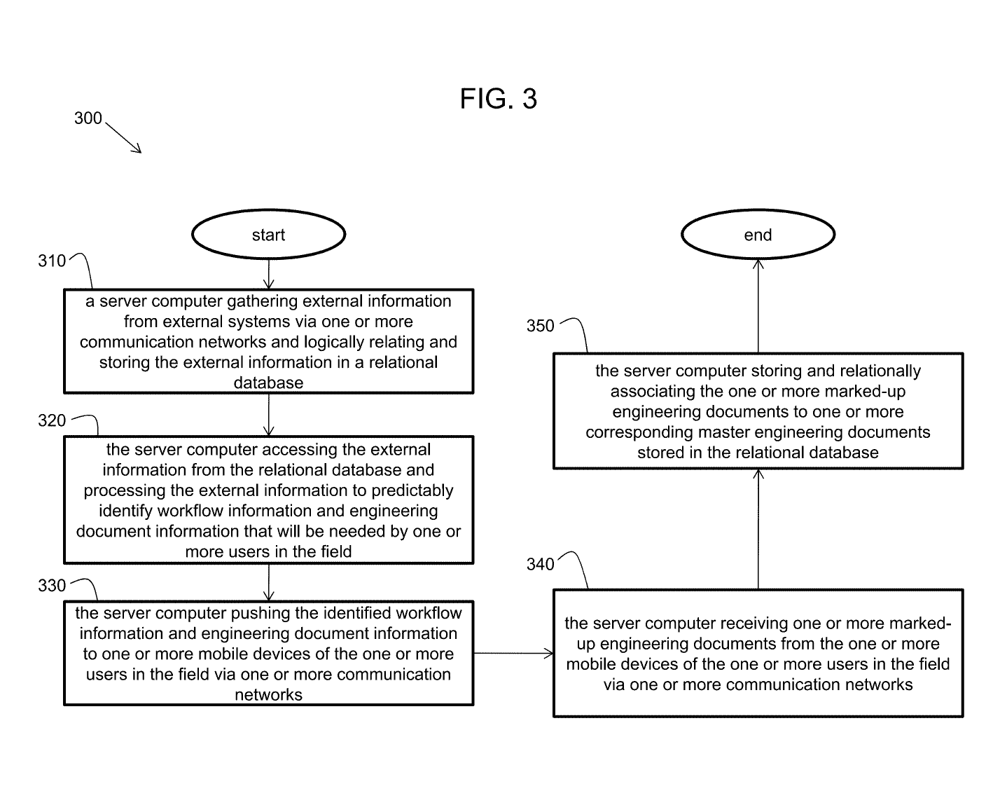

FIG. 3 illustrates a flow chart of an example of a method 300 of providing engineering process and document management to a mobile fleet of users using the systems of FIG. 1 and FIG. 2 which encapsulates the previous example described above herein. In step 310 of the method 300, a server computer gathers external information from external systems via one or more communication networks and logically relates and stores the external information in a relational database. In step 320, the server computer accesses the external information from the relational database and processes the external information to predictably identify workflow information and engineering document information that will be needed by one or more users in the field. In step 330, the server computer pushes the identified workflow information and engineering document information to one or more mobile devices of the one or more users in the field via one or more communication networks. In step 340, the server computer receives one or more modified documents from the one or more mobile devices of the one or more users in the field via one or more communication networks. In step 350, the server computer stores and relationally associates the one or more modified documents to one or more corresponding master engineering documents stored in the relational database.

Workflow information and engineering document information may be stored in the relational database in determined document formats that operate with sophisticated and complex software applications. For example, an engineering drawing may be in the form of a computer-aided design (CAD) document configured to operate with a CAD software application. However, the mobile devices of users in the field may not operate with such document formats. Therefore, a document may be converted by the server computer to a more simplified format. That formatted document may then get pushed to or called by a mobile device. For example, a document in a CAD format may be converted to a document in a PDF format as in the example described previously herein, or a postscript format. Suitable simplified formats may include raster format or vector format, among others. Similarly, a determined set of views may be provided. For example, a 3D CAD model may be simplified to a set of JPEG images that include a perspective view, as well as top, bottom, left, right, front and back views. In another example, the simplified format may be a wire or line drawing, or a cross-sectional view or views.

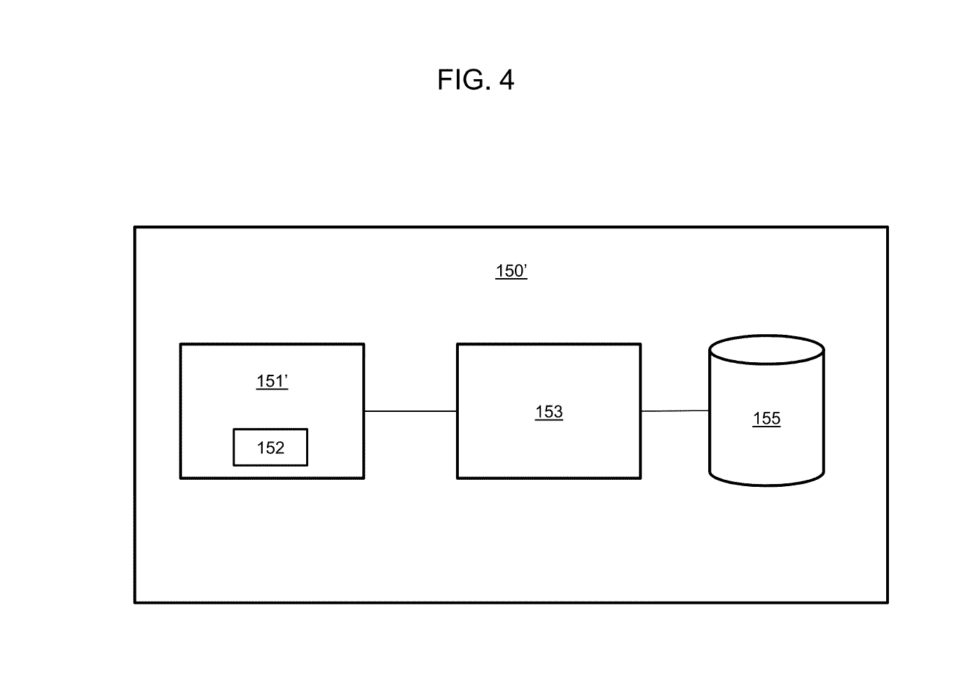

FIG. 4 is an illustration of a second example of an engineering process and document management (EPDM) system 150′ that is similar to the EPDM system of FIG. 2. However, in FIG. 4, the functionality of the server computer of FIG. 2 is divided between two servers which are a predictive caching server computer 151′, having the predictive software application 152, and a relational database server computer 153. The relational database server computer is operatively connected to the predictive caching server computer 151′ and the relational database.

The predictive caching server computer 151′ is responsible for requesting information from the relational database via the relational database server computer, predicting which workflow information and engineering document information will be needed by users in the field, converting document formats, pushing the needed workflow information and engineering document information to the mobile devices of the users in the field via one or more communication networks, and receiving marked-up documents from the mobile devices via one or more communication networks. The relational database server computer 153 is responsible for organizing and managing the workflow information and the engineering document information, gathering external information from the external systems via one or more communication networks, and logically relating and storing the information in the relational database.

Alternatively or complementarily, the functionality of the server computer 151 may be divided up in other ways between two server computers. In yet other arrangements, the functionality of the server computer may be divided up between more than two server computers. Furthermore, more than one relational database may be in operative communication with one or more of the server computers. For example, one relational database may store workflow information and engineering document information, and another relational database may store external information. Other configurations of an EPDM system are possible as well, in accordance with other configurations.

Referring to FIG. 2, the server computer may be accessed by an authorized user (e.g., via a personal computer connected to the internet) such that the authorized user may review one or more modified documents from the field that are stored in the relational database 155, and such that the authorized user may update one or more corresponding master engineering documents stored in the relational database based on the modified documents. The authorized user may be an engineer responsible for maintaining the master engineering documents such that the master engineering documents accurately reflect the equipment and infrastructure in the field.

The EPDM system may request approval of a marked-up document from one or more persons, for example, by sending a request to the one or more persons. Upon receiving a request for approval, a person (e.g., an engineering manager) may access the EPDM system, review and approve the marked-up document, and direct an engineer to update the corresponding master document. In this manner, requests, reviews, and approvals are all performed electronically, reducing or eliminating any need for mailing paper documents around to various persons.

The EPDM system may receive workflow feedback information from the mobile devices of the users in the field via a communication network. The workflow feedback information includes feedback information from the user in the field with respect to the workflow process. For example, a user in the field may figure out a more efficient or effective way to debug a field asset which requires the workflow process to be modified. As a result, the user can provide workflow feedback information which suggests how to modify the workflow process to be more efficient or effective. The workflow feedback information can be related to a corresponding master workflow document and stored in the relational database of the EPDM system. An engineering manager or other authorized user may access the EPDM system to review the workflow feedback information and update a corresponding master workflow document. Workflows can be modified over time to meet current needs or address special circumstances such as safety critical issues or extra-technical requirements.

An authorized auditor may access the EPDM system and perform an audit of the workflow information and the engineering document information stored in the relational database. The authorized auditor may check that the information is up to date, that various process and document control procedures have been properly followed, and that all checks and balances were adhered to. The authorized auditor may be an internal auditor (e.g., a railroad company auditor) or an external auditor (e.g., a government auditor). In general, the EPDM system is able to give management additional insight into workloads, turn-around times, audit and review results, etc.

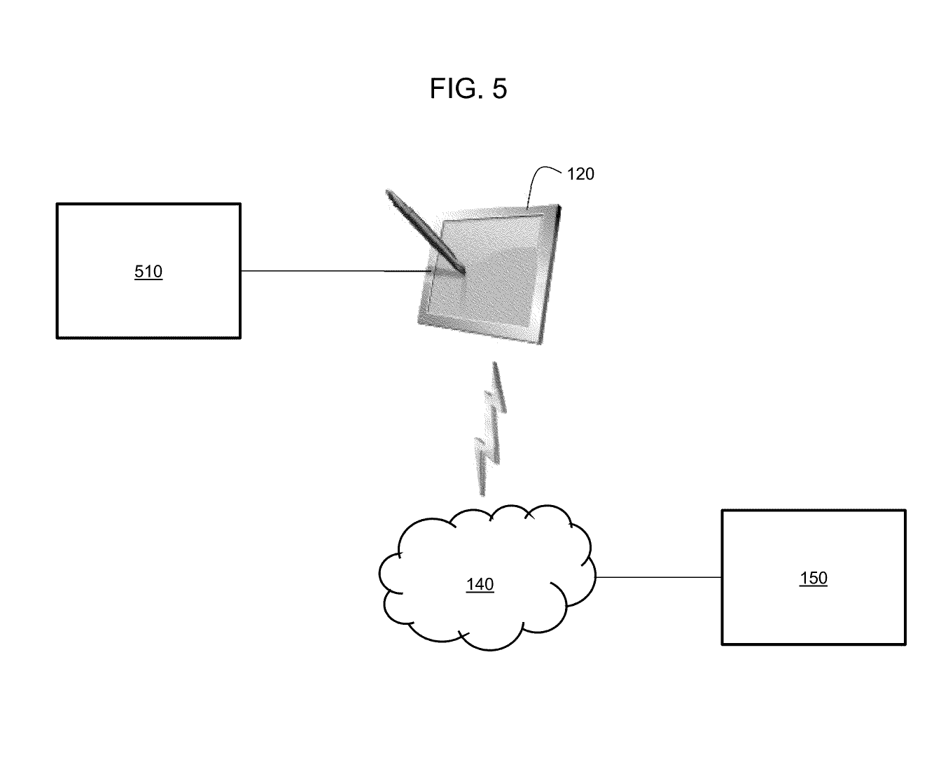

FIG. 5 is an illustration of an example of a mobile device of a user in the field communicatively interacting with a field asset 510 and a process and document management system through a communication network. The field asset may be a microprocessor-based, software controlled device. As discussed previously herein, workflow information and document information that has been predicted to be needed by a user in the field may be pushed to the user's mobile device in a timely manner. The pushed workflow information and document information is related to the field asset to be serviced.

For example, the workflow information may include a workflow process that guides the user through a process of servicing the field asset using a software application on his mobile device. The software application on the mobile device can be programmed to read and process information pushed form the EPDM system and guide the user in servicing the field asset. For example, a field worker may answer questions provided by a decision tree to debug a problem with a field asset. The engineering document information may include an engineering drawing that provides a schematic of the electronic circuitry of the field asset which can be displayed to the user on a display of his mobile device. The software application can allow the user to electronically mark-up (e.g., make notes, lines, circles, sketches, etc.) the engineering drawing on his mobile device to reflect changes made to the electronic circuitry, for example. A touch-sensitive user interface of the user's mobile device may facilitate electronically marking up the engineering drawing.

Sometimes, a user in the field may not be able to readily and reliably access a communication network (be on line) with his mobile device to communicate with the EPDM system. In such a scenario, the user may have to rely on the information already downloaded to his mobile device to service a field asset. That information may or may not be the most current information. However, in an optimized and efficiently operated EPDM system, the chances of the mobile device having the most current information will be quite high. For example, as soon as a mobile device that has been off line comes back on line, the mobile device can automatically report in to the EPDM system and the EPDM system can immediately provide any needed current information to the mobile device.

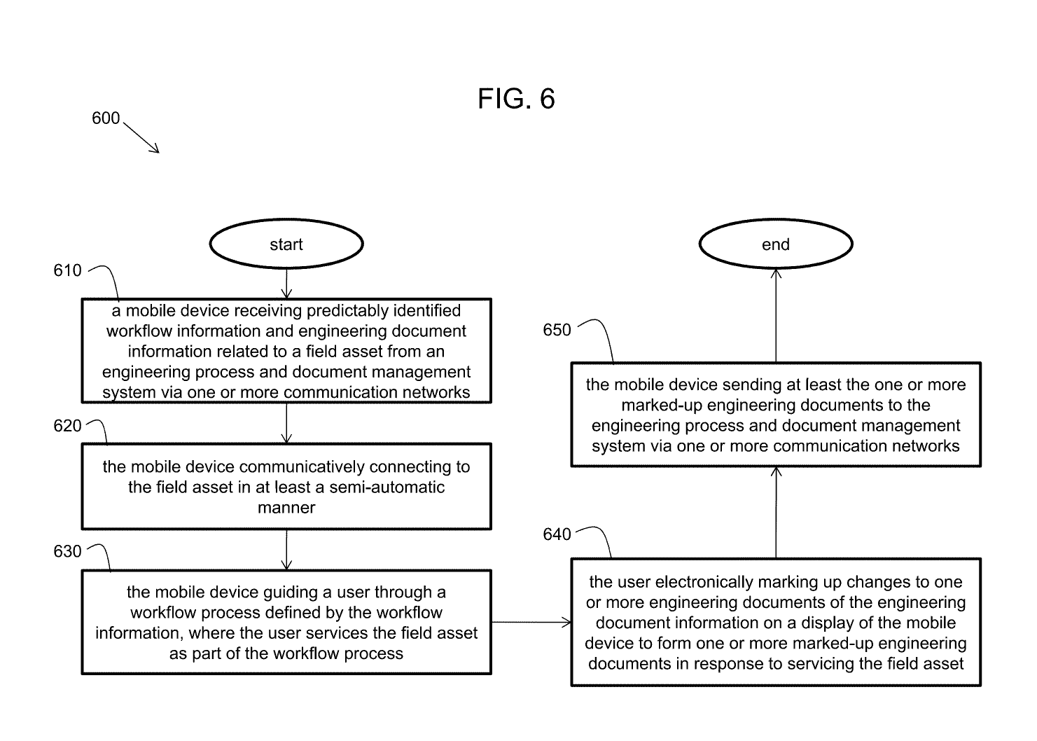

FIG. 6 illustrates a flow chart of an example of a method 600 of servicing a field asset using a mobile device that is supported by a process and document management system. In step 610, the mobile device receives predictably identified workflow information and engineering document information related to a field asset from an engineering process and document management (EPDM) system via one or more communication networks. In step 620, the mobile device communicatively connects to the field asset in at least a semi-automatic manner. For example, a camera on the mobile device may capture an image of a machine-readable code (e.g., a quick response (QR) bar code) displayed on a display of the field asset and interpret the code to determine how to communicatively connect to the field asset. The mobile device can then automatically reconfigure itself to communicate with the field asset, for example, over a serial communication bus physically connected between the mobile device and the field asset, or wirelessly via a wireless connection (e.g., a Bluetooth® connection).

The user of the mobile device does not have to know how to manually set up the communication link between the mobile device and the field asset. The mobile device can include a software application that performs the reconfiguration of the mobile device to communicate with the field asset. The reconfiguration may be done automatically, responsive to a change in external conditions, or upon request by the user. The software application may be programmed to establish communication via multiple different types of communication protocols (e.g., universal serial bus, Ethernet) for multiple different types of field assets.

In step 630, the mobile device guides a user through a workflow process defined by the workflow information. By following the workflow process, the user may perform one or more of base-lining, assessing, inspecting, testing, debugging, repairing, constructing, and modifying the field asset. In step 640, the user electronically marks up changes to one or more engineering documents of the engineering document information on a display of the mobile device, forming one or more modified documents. The marking up of the engineering documents is in response to one or more of base-lining, assessing, inspecting, testing, debugging, repairing, constructing, and modifying the field asset. In step 650, the mobile device sends the modified documents back to the EPDM system via one or more communication networks. As discussed previously herein, the marked-up documents may be reviewed and approved by authorized users of the EPDM system, and the related master documents may be updated accordingly to reflect the changes made in the field.

When servicing certain types of field assets related to a railroad, it may be advantageous to have a train going by as part of the workflow process. For example, to properly test a phase motion sensor on a railroad track, a vehicle such as a train locomotive needs to be moving by the phase motion sensor along the track. A user's mobile device may communicate with the EPDM system via a communication network to correlate the testing of the field asset to a train schedule. The correlation may be performed by a software application of the mobile device or by the EPDM system. For example, the EPDM system may tell the mobile device when trains are scheduled to be passing by the field asset within the next 24 hours. The software application on the mobile device can then schedule a time at which to test the field asset based on the train schedule and based on other tasks that are already scheduled for the user.

As another example, the mobile device can tell the EPDM system that the field asset needs to be tested sometime within the next 48 hours. The EPDM system may already know of the other scheduled tasks for the user over the next 48 hours and can recommend a time at which to test the field asset based on the train schedules and based on the other tasks that are already scheduled for the user. An updated schedule of tasks, including an entry of when to test the field asset when a train is scheduled to go by, can be communicated to the user's mobile device from the EPDM system for the user to accept or reject.

In some scenarios in the field, a second field asset may need to be activated as part of servicing a first field asset. The second field asset may be located remotely from the first field asset. As a result, two persons may be employed to effectively service the first field asset where one person is located at the first field asset and the other person is located at the second filed device.

However, the mobile device of a first user may remotely activate the second field asset upon command of the user. In this manner, a second person located at the second field asset to activate the second field asset can be eliminated from the process. The second field asset may respond to a signal (e.g., a radio frequency signal) from the first user's mobile device.

As an example, a user in the field may be servicing a railroad switch that requires a gate located one hundred feet down the track to be placed in the “up” position before the railroad switch can be activated. The gate can receive and respond to, for example, a Bluetooth® signal from the user's mobile device to activate the gate. The user may use his mobile device to put the gate in the “up” position, from the location of the railroad switch one hundred feet away from the gate, and proceed to service the railroad switch.

As part of base-lining, assessing, inspecting, testing, debugging, repairing, constructing, or modifying a field asset, data may be downloaded from the field asset to the mobile device. The downloaded data may be used by the mobile device as part of servicing the field asset. Alternately, the downloaded data may be forwarded from the mobile device to the EPDM system via one or more communication networks. Such data may include, for example, historical data, key performance indicators (KPI's), analytics, status information, and screen information.

Such data from a field asset may be very helpful, especially when trying to debug an intermittent problem with the field asset. The downloaded data can allow better decisions to be made with respect to servicing the field asset, or can be analyzed by the EPDM system along with data from other similar types of field assets to determine the conditions under which such field assets tend to work properly or have problems.

The EPDM system can track the performance of users in the field by accumulating various metrics and generating score cards. Such metrics can be based on the successful or unsuccessful servicing of field assets as reported to the EPDM system from the mobile devices of the users. Other metrics may include the overall lifetime cost of maintaining an asset, or the rate of replacement part usage, or the cost of maintenance or service over time for the asset, or the interval between asset failures. That is, if two users are each responsible for separate pools of assets and one pool of assets has a mean time between failure interval that is greater than the other user, it may be significant that one of the users is more effective at maintenance than the other user.

The aforementioned systems, components, architectures, environments, and the like have been described with respect to interaction between several components and/or elements. Such devices and elements can include those elements or sub-elements specified therein, some of the specified elements or sub-elements, and/or additional elements. Further yet, one or more elements and/or sub-elements may be combined into a single component to provide aggregate functionality. The elements may also interact with one or more other elements not specifically described herein for the sake of brevity, but known by one of ordinary skill in the art.

In view of the exemplary devices and elements described herein, methodologies that may be implemented in accordance with the disclosed subject matter will be better appreciated with reference to the flow charts. While for purposes of simplicity of explanation, the methodologies are shown and described as a series of block steps, the claimed subject matter is not limited by the order of the block steps, as some block steps may occur in different orders and/or concurrently with other block steps from what is depicted and described herein. Moreover, not all illustrated block steps may be required to implement the methods described herein.

A management system can be provided. The system includes at least one server computer and at least one relational database operatively connected to the at least one server computer and storing workflow information and engineering document information. The server computer gathers external information from external systems via one or more communication networks and logically relate and store the external information in the relational database. The server computer accesses the external information from the relational database and process the external information to predictably identify workflow information and engineering document information that will be needed by one or more users in the field. The server computer can push the identified workflow information and engineering document information to one or more mobile devices of the one or more users in the field via one or more communication networks. The server computer may receive one or more modified documents from the one or more mobile devices of the one or more users in the field via one or more communication networks, and store and relationally associate the one or more modified documents to one or more corresponding master engineering documents stored in the at least one relational database. The server computer may convert at least one document of the engineering-type of document information from a first document format to a second document format before pushing the newly formatted engineering document information to the one or more mobile devices of the one or more users in the field via one or more communication networks. The server computer may be accessed by an authorized user and may allow the authorized user to review the one or more modified documents. The authorized user may have the option to request different, more, or supplemental documents based on that review. The server computer may allow the authorized user to update the one or more corresponding master engineering documents based on the one or more modified documents. The server computer may request approval of the one or more modified documents from one or more persons, and receive approval of the one or more modified documents from the one or more persons. The server computer may receive workflow feedback information from the one or more mobile devices of the one or more users in the field via one or more communication networks, and store and relationally associate the workflow feedback information to one or more corresponding workflows of the workflow information stored in the relational database. The server computer may be accessed by an authorized user, and allow the authorized user to dynamically update the one or more corresponding workflows based on the workflow feedback information. The server computer may be accessed by an authorized user, and allow the authorized user to perform an audit of the workflow information and engineering document information stored in the relational database.

A method can be provided. The method is performed under the control of a software application running on a mobile device. The method includes the mobile device receiving predictably identified workflow information and engineering document information related to a first field asset from the engineering process and document management system described herein via one or more communication networks. The method also includes the mobile device communicatively connecting to the first field asset, and the mobile device guiding a user through a workflow process defined by the workflow information, where the user services the first field asset as part of the workflow process. The method may include the mobile device remotely activating a second remotely located field asset as part of servicing the first field asset. The method may also include the user electronically marking up changes to one or more engineering documents of the engineering document information on a display of the mobile device to form one or more modified documents in response to servicing the first field asset. The method may further include the mobile device sending at least the one or more modified documents to the engineering process and document management system via one or more communication networks. The method may also include the mobile device reading a machine-readable code provided by the first field asset and interpreting the machine-readable code to determine how to communicatively connect to the first field asset. The first field asset may provide the machine-readable code (e.g., a bar code) by displaying the machine-readable code on a display of the first field asset. The method may further include the mobile device communicating with the engineering process and document management system via one or more communication networks to correlate the servicing of the first field asset to at least one train schedule. The method may also include downloading data from the first field asset to the mobile device, and forwarding the data from the mobile device to the engineering process and document management system via one or more communication networks.

In the specification and claims, reference will be made to a number of terms that have the following meanings. The singular forms “a”, “an” and “the” include plural referents unless the context clearly dictates otherwise. Approximating language, as used herein throughout the specification and claims, may be applied to modify any quantitative representation that could permissibly vary without resulting in a change in the basic function to which it is related. Accordingly, a value modified by a term such as “about” is not to be limited to the precise value specified. In some instances, the approximating language may correspond to the precision of an instrument for measuring the value. Similarly, “free” may be used in combination with a term, and may include an insubstantial number, or trace amounts, while still being considered free of the modified term. Moreover, unless specifically stated otherwise, any use of the terms “first,” “second,” etc., do not denote any order or importance, but rather the terms “first,” “second,” etc., are used to distinguish one element from another.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable, or suitable. For example, in some circumstances an event or capacity can be expected, while in other circumstances the event or capacity cannot occur—this distinction is captured by the terms “may” and “may be.”

This written description uses examples to describe systems and methods disclosed herein, including the best mode, and also to enable one of ordinary skill in the art to practice the disclosures, including making and using any devices or systems and performing any incorporated methods. The patentable scope herein is defined by the claims, and may include other examples that occur to one of ordinary skill in the art. Such other examples are intended to be within the scope of the claims if they have structural elements that do not different from the literal language of the claims, or if they include equivalent structural elements with insubstantial differences from the literal language of the claims.

What is claimed is:

1. A management system, comprising:
at least one server computer; and
at least one relational database operatively connected to the at least one server computer and storing workflow information and document information, and
the at least one server computer is configured to gather external information from external systems via one or more communication networks and logically relate and store the external information in the at least one relational database, and
the at least one server computer is configured to access the external information from the at least one relational database and process the external information to predictably identify workflow information and document information that will be needed by one or more users in the field, and
the at least one server computer is configured to push the identified workflow information and document information to one or more mobile devices of the one or more users in the field via the one or more communication networks.

2. The system of claim 1, wherein the at least one server computer is configured to convert at least one document of the document information from a first document format to a second document format before pushing the document information to the one or more mobile devices of the one or more users in the field via the one or more communication networks.

3. The system of claim 1, wherein:
the at least one server computer is configured to receive one or more modified documents from the one or more mobile devices of the one or more users in the field via the one or more communication networks; and
the at least one server computer is configured to store and relationally associate the one or more modified documents to one or more corresponding master documents stored in the at least one relational database.

4. The system of claim, 3 wherein the at least one server computer is configured to:
be accessed by an authorized user; and
allow the authorized user to review the one or more modified documents.

5. The system of claim 4, wherein the at least one server computer is configured to allow the authorized user to update the one or more corresponding master documents based on the one or more modified documents.

6. The system of claim 3, wherein the at least one server computer is configured to request approval of the one or more modified documents from one or more persons.

7. The system of claim 6, wherein the at least one server computer is configured to receive approval of the one or more modified documents from the one or more persons.

8. The system of claim 1, wherein:
the at least one server computer is configured to receive workflow feedback information from the one or more mobile devices of the one or more users in the field via the one or more communication networks; and
the at least one server computer is configured to store and relationally associate the workflow feedback information to one or more corresponding workflows of the workflow information stored in the at least one relational database.

9. The system of claim 8, wherein the at least one server computer is configured to:
be accessed by an authorized user; and
allow the authorized user to dynamically update the one or more corresponding workflows based on the workflow feedback information.

10. The system of claim 1, wherein the at least one server computer is configured to:
be accessed by an authorized user; and
allow the authorized user to perform an audit of the workflow information and document information stored in the at least one relational database.

11. A method performed under the control of a software application running on a mobile device of said one or more mobile devices of claim 1, said method comprising:
the mobile device receiving at least one of predictably identified workflow information and document information related to a first field asset from the management system of claim 1 via the one or more communication networks; and
the mobile device guiding a user through a workflow process defined by the workflow information, wherein the user services the first field asset as part of the workflow process.

12. The method of claim 11, further comprising the mobile device communicatively connecting to the first field asset in at least a semi-automatic manner.

13. The method of claim 11, comprising the user electronically marking up changes to one or more documents of the document information on a display of the mobile device to form one or more modified documents in response to servicing the first field asset.

14. The method of claim 13, comprising the mobile device sending at least the one or more modified documents to the management system via the one or more communication networks.

15. The method of claim 11, comprising the mobile device reading a machine-readable code provided by the first field asset.

16. The method of claim 15, comprising the mobile device interpreting the machine-readable code to determine how to, at least semi-automatically, communicatively connect to the first field asset.

17. The method of claim 15, comprising the first field asset providing the machine-readable code by displaying the machine-readable code on a display of the first field asset.

18. The method of claim 15, wherein the machine-readable code is a bar code.

19. The method of claim 11, comprising the mobile device communicating with the management system via the one or more communication networks to correlate the servicing of the first field asset to at least one vehicle schedule.

20. The method of claim 11, comprising the mobile device remotely activating a second remotely located field asset as part of servicing the first field asset.

21. The method of claim 11, comprising downloading data from the first field asset to the mobile device, and forwarding the data from the mobile device to the management system via the one or more communication networks.
